(19) United States
(12) Patent Application Publication
(10) Pub. No.: US 2015/0268169 A1
(43) Pub. Date: Sep. 24, 2015

(54) ICP Optical Emission Spectrometer

(71) Applicant: Hitachi High-Tech Science Corporation, Tokyo (JP)

(72) Inventors: Yutaka Ikku, Tokyo (JP); Hidenori Tanabe, Tokyo (JP)

(73) Assignee: HITACHI HIGH-TECH SCIENCE CORPORATION, Tokyo (JP)

(21) Appl. No.: 14/661,821

(22) Filed: Mar. 18, 2015

(30) Foreign Application Priority Data
Mar. 19, 2014 (JP) 2014-056998

(51) Int. Cl. G01N 21/73; G01J 3/04; G01J 3/443

(52) U.S. Cl. CPC G01N 21/73; G01J 3/443; G01J 3/04

(57) ABSTRACT

An ICP optical emission spectrometer including: an inductively coupled plasma device configured to atomize or ionize target element to be analyzed using inductively coupled plasma to obtain an atomic emission line; a light condenser configured to condense the atomic emission line, the light condenser including at least two independent light condensers including a first light condenser and a second light condenser; a spectroscope configured to receive the atomic emission line through an incident window and to spectrally detect the atomic emission line; and at least one incident slit that is provided between the first light condenser and the second light condenser, the incident slit being configured to allow the atomic emission line, which passed through the first light condenser, pass through the incident slit and reach to the second light condenser.

### CROSS-REFERENCE TO RELATED APPLICATION

This application claims priority from Japanese Patent Application No. 2014-056998, filed on Mar. 19, 2014, the entire subject matter of which are incorporated herein by reference.

### BACKGROUND

1. Technical Field

The present invention relates to an ICP (Inductively Coupled Plasma) optical emission spectrometer for analyzing elements (for example, trace impurity elements) contained in a sample solution.

2. Description of the Related Art

An ICP optical emission spectrometer performs qualitative and quantitative analysis of trace impurity elements in such a manner that a sample solution for ICP emission spectroscopic analysis is atomized or ionized by inductively coupled plasma (ICP), and atomic emission lines (spectral lines) emitted at that time are spectrally analyzed. The atomic emission lines emitted thus are located in a center portion of the inductively coupled plasma while plasma formation gas such as argon emits light intensively at the outer periphery of the inductively coupled plasma so as to form an intensive background relative to the atomic emission lines. As a result, the signal-to-background ratio (S/B) of the atomic emission lines is lowered during the spectroscopic analysis. There has been known a technique for improving the S/B ratio (see, for example, JP-A-H10-206333).

JP-A-H10-206333 discloses an ICP optical emission spectrometer in which high-frequency power for forming inductively coupled plasma is amplitude-modulated; light emitted from the inductively coupled plasma formed by the high-frequency power is analyzed; a signal component of the same frequency as the amplitude modulation frequency is excluded from a detection signal of the analyzed light; and the signal obtained thus is outputted as a measurement output. The S/B ratio of measurement can be improved without complicating the structure of the apparatus only by the modulation of the high-frequency power, so that the sensitivity of the ICP emission spectroscopic analysis can be improved. Thus, the sensitivity of the ICP emission spectroscopic analysis can be improved.

However, only one light condenser is located in a route extending from the atomic emission lines to a spectroscope as disclosed in JP-A-H10-206333. Therefore, according to the ICP optical emission spectrometer of this type, it may be difficult to perfectly eliminate the background light.

### SUMMARY

The present invention has been made in view of the above-described circumstances, and one of objects of the present invention is to provide an ICP optical emission spectrometer in which a background existing around atomic emission lines are eliminated by a plurality of light condensers so as to improve the S/B ratio of the atomic emission lines.

According to an exemplary embodiment of the present invention, there is provided an ICP optical emission spectrometer including: an inductively coupled plasma device configured to atomize or ionize target element to be analyzed using inductively coupled plasma to obtain an atomic emission line; a light condenser configured to condense the atomic emission line, the light condenser including at least two independent light condensers including a first light condenser and a second light condenser; a spectroscope configured to receive the atomic emission line through an incident window and to spectrally detect the atomic emission line; and at least one incident slit that is provided between the first light condenser and the second light condenser, the incident slit being configured to allow the atomic emission line, which passed through the first light condenser, pass through the incident slit and reach to the second light condenser.

### BRIEF DESCRIPTION OF THE DRAWINGS

The above and other aspects of the present invention will become more apparent and more readily appreciated from the following description of illustrative embodiments of the present invention taken in conjunction with the attached drawings, in which:

FIG. 1 is a conceptual diagram showing an example of an ICP optical emission spectrometer according to the present invention;

FIG. 2 is a schematic diagram of an example of a first embodiment of a light condenser in the ICP optical emission spectrometer according to the present invention;

FIG. 3 is a schematic diagram of an example of a second embodiment of the light condenser in the ICP optical emission spectrometer according to the present invention;

FIG. 4 is a schematic diagram showing a light source size based on optical simulation in the ICP optical emission spectrometer according to the present invention; and

FIG. 5 is a block diagram of the ICP optical emission spectrometer according to the present invention.

### DETAILED DESCRIPTION

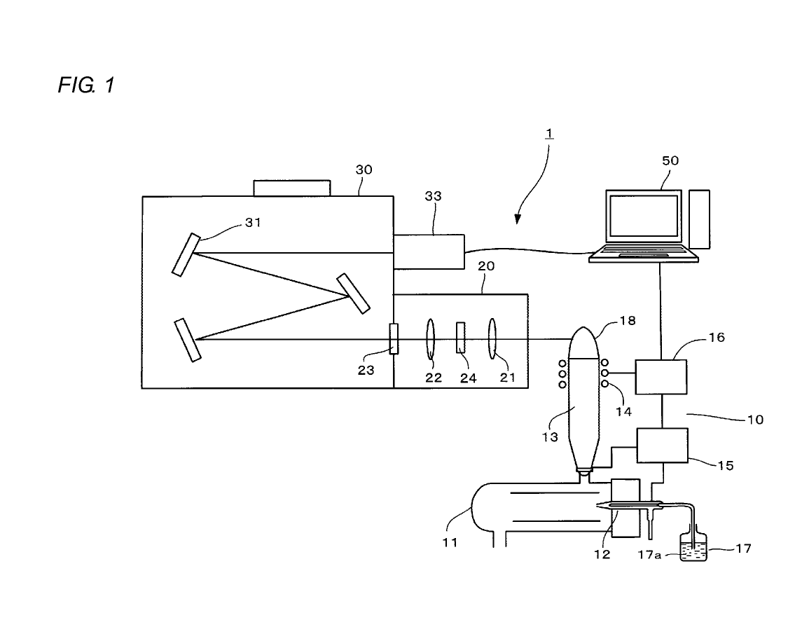

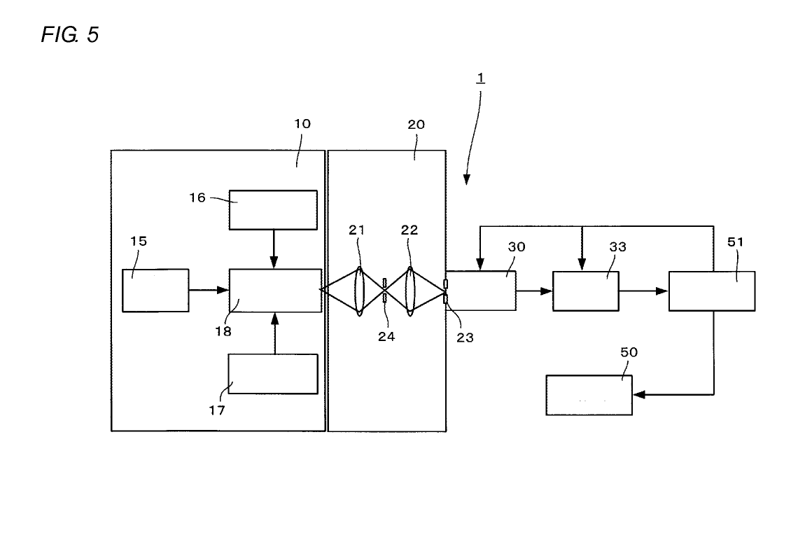

A preferred embodiment of an ICP optical emission spectrometer according to the present invention will be described below in detail with reference to FIG. 1 to FIG. 6.

FIG. 1 is a conceptual diagram showing an example of an ICP optical emission spectrometer according to an embodiment of the present invention.

An ICP optical emission spectrometer 1 is configured to be provided with: an inductively coupled plasma device 10, a light condenser 20, a spectroscope 30 and a controller 50. The inductively coupled plasma device 10 is provided with a spray chamber 11, a nebulizer 12, a plasma torch 13, a high-frequency coil 14, a gas controller 15 and a high-frequency power source 16. The light condenser 20 is disposed between the inductively coupled plasma device 10 and the spectroscope 30 and provided with a first condenser 21, a second condenser 22, a slit-like incident window (slit type incident window) 23 and an incident slit 24.

The spectroscope 30 has optical components 31 including a diffraction grating, a mirror, etc., and a detector 33.

Carrier gas (argon gas) supplied into the nebulizer 12 is sprayed into the spray chamber 11 from the front end of the nebulizer 12. Due to negative pressure suction of the carrier gas, a sample solution 17a in a sample vessel 17 is sucked up and jetted from the front end of the nebulizer 12. In the spray chamber 11, homogenization of particles and stabilization of airflow are performed on the sample solution 17a jetted thus. The sample solution 17a is controlled by the gas controller 15 and guided into the plasma torch 13. Then, a high-frequency current from the high-frequency power source 16 is applied to the high-frequency coil 14 so that sample molecules (or atoms) of the sample solution 17a are heated and excited to emit light. Thus, an inductively coupled plasma 18 (hereinafter referred to as plasma) is generated above the plasma torch 13.

Atomic emission lines in which elements of the sample solution 17a to be analyzed have been atomized or ionized by the plasma 18 are incident on the light condenser 20 which condenses the atomic emission lines. The atomic emission lines pass through the first light condenser 21 and the incident slit 24 and then pass through the second light condenser 22 and the slit type incident window 23. After that, the atomic emission lines enter into the spectroscope 30. The incident slit 24 serves to allow the passage of the atomic emission lines having passed through the first light condenser 21, and to send the atomic emission lines to the second light condenser 22.

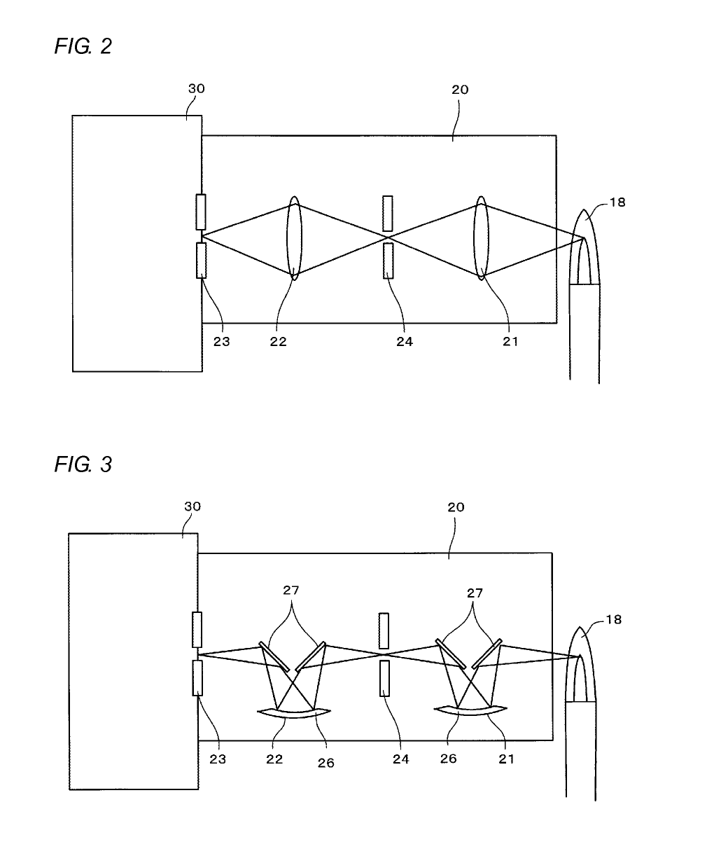

In the first embodiment shown in FIG. 2, each of the two independent light condensers, that is, each of the first light condenser 21 and the second light condenser 22 includes a condenser lens. In addition, the incident slit 24 is provided between the first light condenser 21 and the second light condenser 22, and the slit type incident window 23 is provided in a border portion between the light condenser 20 and the spectroscope 30.

An example of the positional relationship among constituents, etc. will be described below. When the position of atomic emission lines is expressed as Z=0, the position of the first light condenser 21 is expressed as Z=92.414 mm; the position of the incident slit 24, as Z=255 mm; the position of the second light condenser 22, as Z=297.861 mm; and the position of the slit type incident window 23, as Z=315 mm. In addition, quartz lenses are used as the condenser lenses of the first light condenser 21 and the second light condenser 22. The condenser lens of the first light condenser 21 has a curvature radius of 55 mm, a thickness of 15 mm, a focal distance of f=58.9, and an effective diameter of 25 mm. The condenser lens of the second light condenser 22 has a curvature radius of 10 mm, a thickness of 10 mm, a focal distance of f=12.2, and an effective diameter of 8 mm.

The embodiment is not limited to the aforementioned exemplary numeric values.

In a second embodiment shown in FIG. 3, each of the two independent light condensers, that is, each of the first light condenser 21 and the second light condenser 22 includes a concave mirror 26 and two plane mirrors 27. In the same manner as in the first embodiment, the incident slit 24 is provided between the first light condenser 21 and the second light condenser 22, and the slit type incident window 23 is provided in a border portion between the light condenser 20 and the spectroscope 30.

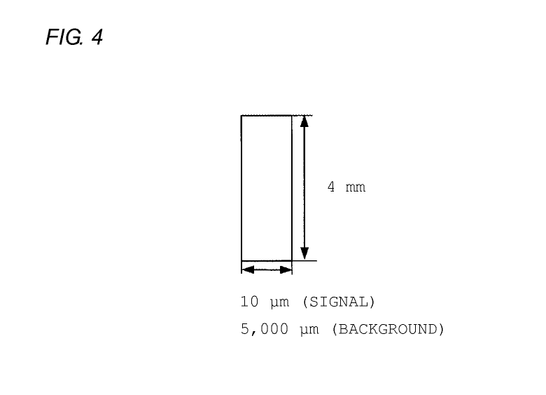

FIG. 4, Table 1 and Table 2 show contents and results based on optical simulation.

TABLE 1

| Light Source | Incident Slit 24 | Incident Window 23 |
|---|---|---|
| signal | 2.34E−03 [W] | 9.91E−04 [W] |
| background | 1.92E−03 [W] | 7.25E−05 [W] |

TABLE 2

| | Incident Slit 24 | Incident Window 23 |
|---|---|---|
| SB ratio | 1.22 | 13.67 |

Specifically, FIG. 4 shows the size of a signal source and the size of a background source used in the optical simulation. The size of an atomic emission source as a signal was regarded as a surface light source measuring 4 mm by 10 μm, and the size of a background emission source was regarded as a surface light source measuring 4 mm by 5,000 μm. It is also assumed that the size of each of the slit type incident window 23 and the incident slit 24 measured 4 mm by 10 μm.

Table 1 shows results of the optical simulation and shows signal intensity and background intensity entering the incident slit 24 and the slit type incident window 23. The signal intensity was obtained on the assumption that a total of 25 W of light was emitted to a direction of 4πSr from the surface light source measuring 4 mm and 10 μm. The background intensity was obtained on the assumption that a total of 1 W of light was emitted to a direction of 4πSr from the surface light source measuring 4 mm and 5,000 μm.

In the ICP optical emission spectrometer 1, since a first light condenser 21 and a second light condenser 22 are provided to form a plurality of light condensers, and an incident slit 24 is provided between the first light condenser 21 and the second light condenser 22, a background existing around atomic emission lines is eliminated and the signal-to-background ratio (S/B) of the atomic emission lines is improved.

Although description has been made about the first light condenser 21 and the second light condenser 22, one or more other light condensers (a third light condenser, a fourth light condenser . . . ) and other incident slits may be provided.

FIG. 6 is a block diagram of the ICP optical emission spectrometer 1 according to the present invention.

Atomic emission lines in which elements to be analyzed have been atomized or ionized by the plasma 18 are incident on the light condenser 20 which condenses the atomic emission lines. The atomic emission lines pass through the first light condenser 21 and the incident slit 24 and then pass through the second light condenser 22 and the slit type incident window 23. After that, the atomic emission lines enter into the spectroscope 30. The atomic emission lines passing through the spectroscope 30 and converted into amplification signals are operated in an amplification operation portion 51 and recorded in the controller 50 as measurement data. The amplification operation portion 51 performs wavelength sweeping control on the spectroscope 30 and performs control of detector voltage, integration time, etc. on the detector 33.

The present invention is not limited to the aforementioned embodiments but modifications, improvements, etc. may be made thereon suitably. In addition, materials, shapes, numeric values, forms, numbers, arrangement places, etc. of constituent elements in the aforementioned embodiments are not limited but may be set desirably as long as the invention can be attained.

An ICP optical emission spectrometer according to the present invention may be applied to applications for improving the signal-to-background ratio (S/B) of atomic emission lines.

What is claimed is:

1. An ICP optical emission spectrometer comprising:
an inductively coupled plasma device configured to atomize or ionize target element to be analyzed using inductively coupled plasma to obtain an atomic emission line;
a light condenser configured to condense the atomic emission line, the light condenser comprising at least two independent light condensers including a first light condenser and a second light condenser;
a spectroscope configured to receive the atomic emission line through an incident window and to spectrally detect the atomic emission line; and
at least one incident slit that is provided between the first light condenser and the second light condenser, the incident slit being configured to allow the atomic emission line, which passed through the first light condenser, pass through the incident slit and reach to the second light condenser.

2. The ICP optical emission spectrometer according to claim 1,
wherein each of the first light condenser and the second light condenser comprises a condenser lens.

3. The ICP optical emission spectrometer according to claim 1,
wherein each of the first light condenser and the second light condenser comprises a concave mirror and a plane mirror.
